(19) United States
(12) Patent Application Publication
(10) Pub. No.: US 2008/0178118 A1
(43) Pub. Date: Jul. 24, 2008

(54) Navigation Device

(75) Inventors: Takaaki Ishii, Tokyo (JP); Tsugumichi Owaki, Tokyo (JP); Takashi Yoshimaru, Tokyo (JP); Mami Nomura, Tokyo (JP); Hitoshi Yamadera, Kanagawa (JP); Kazumi Matsumoto, Tokyo (JP); Noriaki Aoyama, Saitama (JP)

Correspondence Address: CROWELL & MORING LLP;INTELLECTUAL PROPERTY GROUP, P.O. BOX 14300, WASHINGTON, DC, 20044-4300, US

(73) Assignee: Xanavi Informatics Corporation, Zama-shi (JP)

(21) Appl. No.: 11/662,877

(22) PCT Filed: May 18, 2005
(86) PCT No.: PCT/JP2005/009050

§ 371 Date: Nov. 6, 2007

(30) Foreign Application Priority Data
Sep. 16, 2004 (JP) 2004-269885

(51) Int. Cl. G06F 3/048

(52) U.S. Cl. 715/810

(57) ABSTRACT

A navigation device includes: a display device; a control device that controls the display device so as to display a plurality of indexes to be selected in order to operate predetermined functions; and an instruction device with which a user gives an instruction to select among the plurality of indexes that are displayed. And the control device displays the plurality of indexes so that the plurality of indexes are arranged in two columns in a vertical direction, indexes that are arranged in one of the two columns and indexes that are arranged in the other of the two columns are mutually displaced in a vertical direction, and the indexes that are arranged in at least the one of the two columns have shapes that project towards the other of the two columns of indexes.

### TECHNICAL FIELD

The present invention relates to a navigation device that displays indexes.

### BACKGROUND ART

A navigation device is known (Patent Reference #1) in which a list consisting of rectangular indexes is displayed upon a display section.

### Patent Reference #1: Japanese Laid-Open Patent Publication 2003-75171

### DISCLOSURE OF THE INVENTION

### PROBLEMS TO BE SOLD BY THE INVENTION

With a sequential line of indexes as described in Patent Reference #1, when a large number of indexes are displayed upon the screen in the form of such a list, the vertical extent of each of the indexes becomes short. Due to this the problem arises that, if the indexes are displayed upon a touch panel and an index is to be selected by pressing down upon the display portion for the desired index with a finger, it becomes difficult to perform selection of that index.

### MEANS FOR SOLVING THE PROBLEMS

According to the 1st aspect of the present invention, a navigation device, comprises: a display device; a control device that controls the display device so as to display a plurality of indexes to be selected in order to operate predetermined functions; and an instruction device with which a user gives an instruction to select among the plurality of indexes that are displayed. And the control device displays the plurality of indexes so that the plurality of indexes are arranged in two columns in a vertical direction, indexes that are arranged in one of the two columns and indexes that are arranged in the other of the two columns are mutually displaced in a vertical direction, and the indexes that are arranged in at least the one of the two columns have shapes that project towards the other of the two columns of indexes.

According to the 2nd aspect of the present invention, in the navigation device according to the 1st aspect, it is preferred that the control device displays the plurality of indexes so that the indexes that are arranged in the one of the two columns have shapes that project towards the other of the two columns of indexes, and the indexes that are arranged in the other of the two columns have shapes that project towards the one of the two columns of indexes.

According to the 3rd aspect of the present invention, in the navigation device according to the, 2nd aspect, it is preferred that the control device displays the plurality of indexes so that portions of indexes that are arranged in the one of the two columns are arranged between two indexes adjacent to each other in the other of the two columns, and portions of indexes that are arranged in the other of the two columns are arranged between two indexes adjacent to each other in the one of the two columns.

According to the 4th aspect of the present invention, in the navigation device according to the 1st aspect, it is preferred that the control device displays the plurality of indexes so that portions of indexes that are arranged in the one of the two columns are arranged between two indexes adjacent to each other in the other of the two columns.

According to the 5th aspect of the present invention, in the navigation device according to any one of the 1st through 4th aspects, it is preferred that: the instruction device comprises a touch panel that is provided upon a display screen of the display device, and outputs a signal related to a position at which the touch panel is pressed to the control device; and the control device decides that an index corresponding to the pressed position has been selected, based upon the signal related to the pressed position.

According to the 6th aspect of the present invention, in the navigation device according to the 5th aspect, it is preferred that: the instruction device further comprises, in addition to the touch panel, an actuation member that is actuated for selecting among the indexes; and the control device displays the indexes in the one of the two columns and the indexes in the other of the two columns to be sequentially and alternately selected, when the actuation member is continually actuated.

According to the 7th aspect of the present invention, in the navigation device according to any one of the 1st through 4th aspects, it is preferred that: the instruction device comprises an actuation member that is actuated for selecting among the indexes; and the control device displays the indexes in the one of the two columns and the indexes in the other of the two columns to be sequentially and alternately selected, when the actuation member is continually actuated,.

According to the 8th aspect of the present invention, in the navigation device according to the 6th or the 7th aspect, it is preferred that: the actuation member is a rotary actuation member; any one of the indexes is selected by rotational actuation of the rotary actuation member; and there is further provide a confirmation actuation member that is actuated in order to confirm the selected index.

### ADVANTAGEOUS EFFECT OF THE INVENTION

According to the present invention, a display is provided that can be easily viewed when making a selection, even if the number of indexes becomes great. Furthermore, if a touch panel is provided, it becomes simple to select an index by pressing it.

### BRIEF DESCRIPTION OF THE DRAWINGS

FIG. 1 is a block diagram showing the structure of a navigation device according to an embodiment of the present invention;

FIG. 2 is a schematic figure showing the external appearance of this navigation device as mounted in a vehicle;

FIG. 3 is a sectional view of a touch panel;

FIG. 4 is a figure for explanation of calculation of the position where this touch panel is being pressed;

FIG. 5 is a figure for explanation of a display screen displayed upon a touch panel of this navigation device according to the first embodiment of the present invention;

FIG. 6 is a figure for explanation of a problem which arises when indexes are simply displayed in two columns;

FIG. 7 is a figure for explanation of a display screen displayed upon a touch panel of a navigation device according to a second embodiment of the present invention; and

FIG. 8 is a figure for explanation of a display screen displayed upon a touch panel of a navigation device according to a third embodiment of the present invention.

### BEST MODE FOR CARRYING OUT THE INVENTION

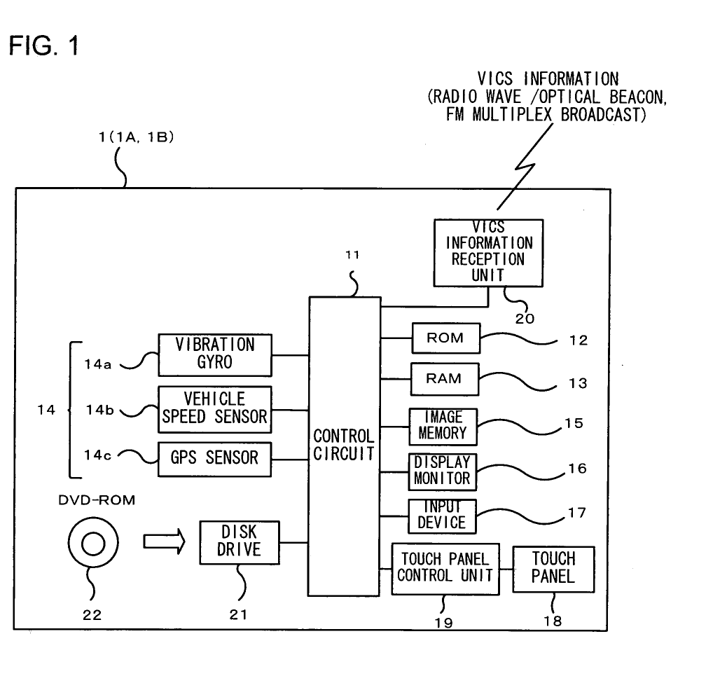

FIG. 1 shows the structure of a navigation device according to one embodiment of the present invention. The navigation device of FIG. 1 is adapted so that input actuation for its normal navigation functions of map display or the like can not only be performed via an input device 17, but also via a touch panel 18. This navigation device 1 comprises a control circuit 11, a ROM 12, a RAM 13, a current position detection device 14, an image memory 15, a display monitor 16, the input device 17, the touch panel 18, a VICS (road traffic information system) information reception unit 20, and a disk drive 21. The touch panel 18 is a transparent touch switch which is laminated upon the surface of the display monitor 16. In this specification, the image which is displayed upon the display monitor 16 will be described as being displayed upon the touch panel 18. A touch panel control unit 19 is connected to the touch panel 18, and calculates the position where the touch panel 18 is being pressed according to signals from the touch panel 18. A DVD-ROM 22 upon which map data is recorded is loaded into the disk drive 21. This map data includes data for displaying maps, data for route searching, and the like. The data for displaying maps includes map data at a plurality of scales from wide area to detail, so that the scale of the map which is being displayed can be changed according to requests from the operator.

The control circuit 11 comprises a micro processor and its peripheral circuitry, and performs various types of control by executing a control program which is stored in the ROM 12, using the RAM 13 as a work area. When this control circuit 11 performs predetermined route search processing according to the map data stored upon the DVD-ROM 22, the result of this processing is displayed upon the touch panel 18 as a recommended route.

The current position detection device 14 is a device which detects the current position of the vehicle, and it may comprise, for example, a vibration gyro 14a which detects the azimuth of progression of the vehicle, a vehicle speed sensor 14b which detects the vehicle speed, a GPS (Global Positioning System) sensor 14c which detects GPS signals from GPS satellites, and the like. The navigation device 1, along with determining the display range for the map and a route search start point and the like, also displays the current position of the vehicle upon the map based upon the current position which has been detected by this current position detection device 14.

The image memory 15 stores image data for display upon the touch panel 18. This image data consists of data for drawing road maps and various types of drawing data, which are generated appropriately based upon the map data stored upon the DVD-ROM 22 as read in by the disk drive 21. The navigation device 1 is able to perform map display and the like by using the image data which has been generated in this manner.

Based upon various types of information such as the map data and the like, the display monitor 16 provides to the driver various types of information such as a road map of the vicinity of the current vehicle position and the like. The input device 17 comprises input switches for the operator to set various types of commands, and these are implemented by an actuation (operation) panel or a remote control or the like. The operator selects a destination and sets that destination by actuating the input device 17 manually in response to commands upon the screen displayed upon the touch panel 18. As described above, the touch panel 18 is a transparent panel which is provided over the monitor screen of the display monitor 16, so that the monitor screen which is displayed upon the display monitor 16 is visible through the touch panel 18. The touch panel 18 has the same input functions as the input device 17, and, when the map screen or some button or display menu or the like displayed upon the touch panel 18 is pressed with a finger, the position where the touch panel 18 is being pressed is calculated by the touch panel control unit 19, and a destination is set or a function is executed which corresponds to the button or display menu. For example, if a scroll button which is displayed upon the touch panel 18 is pressed, it is possible to scroll the map screen or a selection menu or the like.

When the destination is set by the driver, the navigation device 11 performs route calculation to the destination according to a predetermined algorithm, taking the current position which has been detected by the GPS sensor 14c as a starting point. The route which has been obtained in this manner (hereinafter termed the “searched route”) is displayed upon the screen in a display format in which it can be distinguished from the other roads, for example by its display color or the like being changed. Due to this, the driver is able to recognize the searched route in the map upon the screen. Furthermore, the navigation device 1 issues travel direction commands to the driver via the screen or by audio or the like so that the vehicle can be driven according to the searched route, and thereby the vehicle is guided.

The VICS information reception unit 20 receives VICS information such as traffic-jam (congestion) information and the like which is provided from a VICS information center not shown in the figures, and outputs this VICS information to the control circuit 11. This VICS information is transmitted by radio wave beacons which are mostly installed above high speed roads, or by optical beacons which are mostly installed above normal roads, or by FM multiplex broadcasts. The navigation device 1 receives the VICS information which is transmitted from these devices with the VICS information reception unit 20.

The disk drive 21 reads out, from the DVD-ROM 22 which has been loaded, map data for display of the map upon the display monitor 16, in other words upon the touch panel 18. It should be understood that it would also be acceptable to arrange for the map data to be read out from some other type of recording medium than the DVD-ROM 22, for example from a CD-ROM or a hard disk or the like.

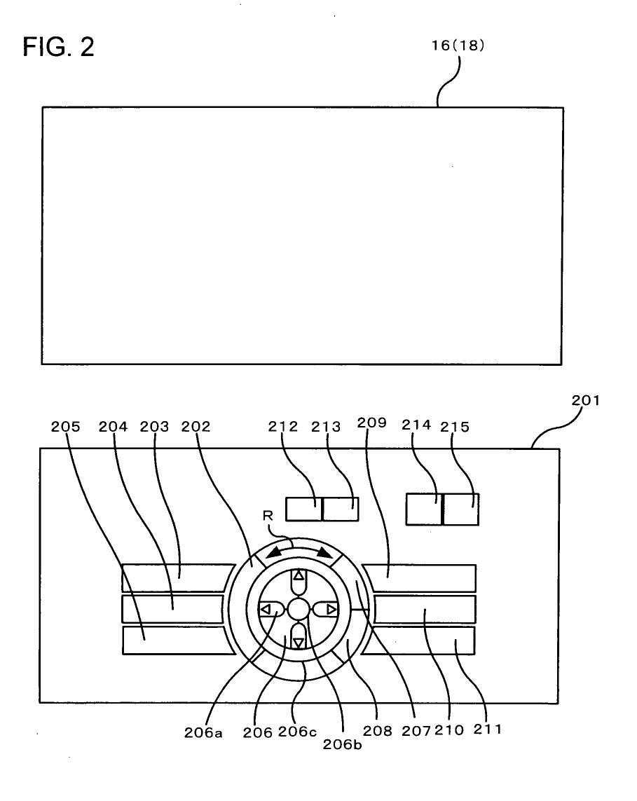

FIG. 2 is a schematic figure showing the external appearance of this navigation device according to the first embodiment of the present invention when it has been mounted to a center console portion in a vehicle. The touch panel 18 which is provided upon the screen of the display monitor 16 is installed in the upper portion of the center console, while an actuation panel 201 which corresponds to the input device 17 is installed in the lower portion of the center console. In other words, this actuation panel 201 is provided in a position which is different from being upon the screen of the display monitor 16.

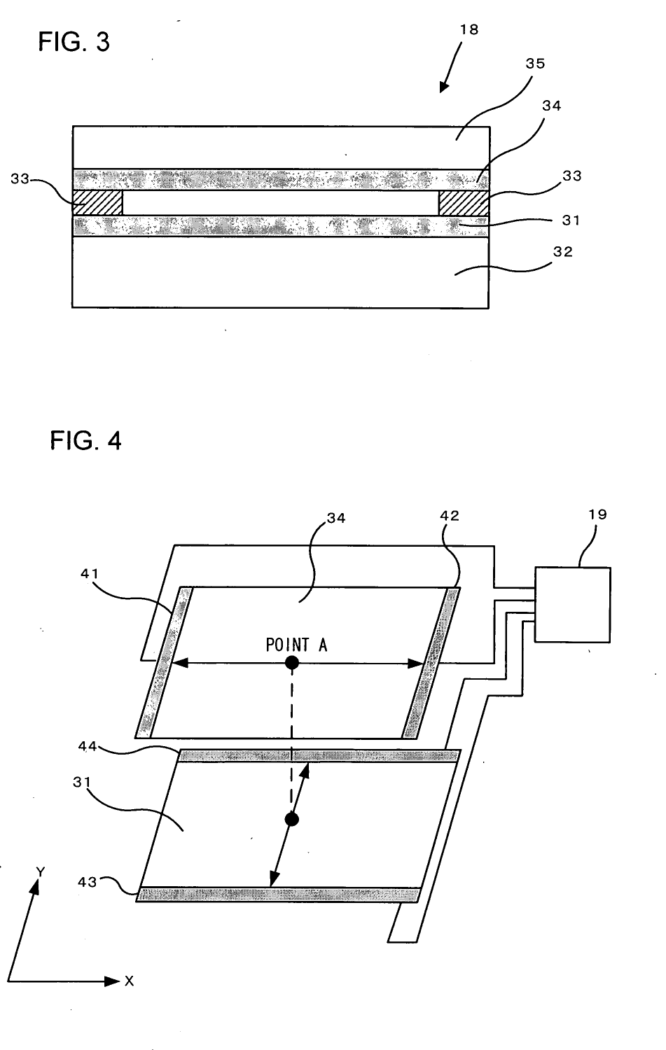

The position where the touch panel 18 shown in FIG. 2 is being pressed is calculated by the following method. First, the theory of this touch panel will be explained with reference to FIG. 3. FIG. 3 is a figure showing a cross section of the touch panel 18. The touch panel 18 is manufactured by gluing a PET (Polyethylene Terephthalate) film 35 upon which a transparent electrically conductive layer 34 made from ITO (Indium Tin Oxide) or the like is formed, to a glass substrate 32 upon which is formed another transparent electrically conductive layer 31 made from ITO or the like, with spacers 33 being sandwiched between them. Since the PET film 35 is flexible, when the surface of this PET film 35 is pressed, a short-circuit is established at the position at which the transparent electrically conductive layer 34 formed upon the PET film 35 and the transparent electrically conductive layer 31 formed upon the glass substrate 32 are pressed together.

FIG. 4 is a figure for explaining the theory of operation of the touch panel 18. The position where this pressing together has been performed and a short-circuit has been established is supposed to be the point A in FIG. 4. X axis electrodes 41, 42 are formed on the transparent electrically conductive layer 34 which is formed upon the PET film 35. And Y axis electrodes 43, 44 are formed upon the transparent electrically conductive layer 31 which is formed upon the glass substrate 32. And the X axis electrodes 41, 42 and the Y axis electrodes 43, 44 are connected to the touch panel control unit 19. When the position A is pressed down, and when a voltage is applied between the X axis electrodes 41, 42, a voltage is detected at the Y axis electrodes 43, 44, since the transparent electrically conductive layers 31 and 34 are short-circuited together. The X coordinate of the position which is being pressed is calculated by the touch panel control unit 19 from the voltage value which is detected. On the other hand, when a voltage is applied between the Y axis electrodes 43, 44, a voltage is detected at the X axis electrodes 41, 42 in the same manner. The Y coordinate of the position which is being pressed is calculated by the touch panel control unit 19 from the voltage value which is detected. And, according to the above, the position (X,Y) of the position A which is being pressed may be calculated by alternatingly applying voltage between the X axis electrodes 41, 42 and between the Y axis electrodes 43, 44. The position A which is being pressed which has been calculated in this manner is outputted to the control circuit 11 as a position signal.

When from this position signal it is decided that the position of pressing is within the display range of a button such as an index or the like which is being displayed upon the touch panel 18, then the control circuit 11 decides that this button (index) is being selected, and operates the function which has been allocated to that button. Here a button upon which a character or an icon is displayed is termed an index. Such an index is a mark from which the function which is allocated thereto can be understood at a glance.

Various buttons and switches are provided upon the actuation panel 201 of FIG. 2, which is the input device 17 of the navigation device 1. In detail, upon this actuation panel 201, there are provided a return button 202, a menu screen display button 203, an information/TV button 204, an audio button 205, an eight direction and confirmation (decision) switch 206, a wide area button 207, a detail button 208, a navigation menu button 209, a current position button 210, a set button 211, a state display button 212, a screen/delete button 213, a first favorite button 214, and a second favorite button 215.

The return button 202 is endowed with the function of returning from each screen during item setting to the previous screen. Furthermore, on the final screen during item setting, it fulfills a confirmation role. The menu screen button 203 is endowed with the function of displaying the menu screen of the navigation device 1. The information/TV button 204 is endowed with the function of displaying a menu screen related to information/TV (not shown in the figures). And the audio button 205 is endowed with the function of displaying a menu screen related to audio (not shown in the figures).

The eight direction and confirmation switch 206 comprises an eight direction button 206a, a confirmation button 206b, and a rotary switch 206c. The eight direction button 206a is endowed with the functions of scrolling the map which is displayed upon the touch panel 18 in eight directions and selecting buttons upon the screen of the touch panel, by four buttons upon which triangle marks are affixed and four buttons which are located between these four above buttons being pressed and actuated. The confirmation button 206b is endowed with the function of causing a screen to be displayed for performing the details of the button which has been selected. And the rotary switch 206c is positioned at the external circumferential portion of the eight direction and confirmation switch 206, and can be rotationally actuated in the direction of the arrow sign R. By this rotational actuation of the rotary switch 206c, the function is provided of selecting a button such as an index or the like which is displayed upon the touch panel 18.

The wide area button 207 is endowed with the function of changing over the scale of the map display to small scale. The detail button 208 is endowed with the function of changing over the scale of the map display to large scale. The navigation menu button 209 is endowed with the function of displaying a menu screen of this navigation system. The current position button 210 is endowed with the function of displaying a map screen and a current position menu for the current position. The set button 211 is endowed with the function of displaying a setting menu screen. The state display button 212 is endowed with the function of displaying the operational states of an air conditioner (not shown in the figures) and of an audio system (also not shown in the figures). The screen/delete button 213 is endowed with the functions of deleting the display screen upon the touch panel 18, and of adjusting the screen display color, brightness, and contrast. And the first favorite button 214 and the second favorite button 215 are endowed with the functions of performing functions which are registered to those respective buttons.

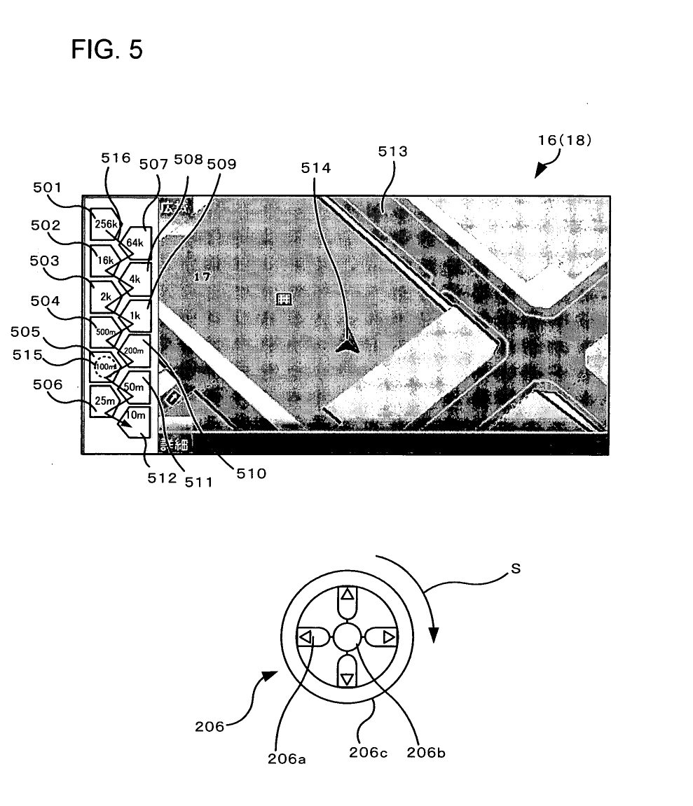

Next, the indexes which are used by this navigation device 1 according to the first embodiment of the present invention will be explained with reference to FIG. 5. FIG. 5 is a figure for explanation of the screen displayed upon the touch panel 18, upon which these indexes of the navigation device 1 according to the first embodiment of the present invention are displayed. Indexes 501 through 512 and a map 513 are displayed upon the display panel 18. Predetermined distances are displayed upon these indexes 501 through 512, and, when one of the indexes 501 through 512 is pressed down for greater than or equal to a predetermined time period, a map 513 is displayed at a scale at which the distance which is being displayed upon this index is equivalent to the horizontal width of the map 513. For example, when the index 511 is pressed down with a finger, a map 513 is displayed at a scale at which the horizontal width of the map 513 is equivalent to 50 m.

As shown in FIG. 5, with this navigation device according to the first embodiment of the present invention, the indexes 501 through 512 are displayed as arranged in two columns side by side in the vertical direction. The indexes 501 through 506 in the left side column are positioned above the indexes 507 through 512 in the right side column by just one half of the height of the indexes. Each of the indexes 501 through 512 presents a pentagonal shape which consists of an isosceles triangle against one side of a quadrilateral, and the vertexes of their triangular shapes point in left and right directions. In more detail, the vertexes of the indexes 501 through 506 in the left side column point to the right, while the vertexes of the indexes 507 through 512 in the right side column point to the left. Furthermore, the rightward pointing vertexes on the right side of the left side column point between the indexes of the right side column, while the leftward pointing vertexes of the right side column point between the indexes of the left side column. To put it in another manner, the indexes 501 through 506 in the left side column are shaped as convex (projecting) towards the indexes 507 through 512 in the right side column, while the indexes 507 through 512 in the right side column are shaped as convex (projecting) towards the indexes 501 through 506 in the left side column.

Not only may the index buttons 501 through 512 be selected and confirmed by pressure upon the touch panel 18, but also they may be selected with the rotary switch 206c of the eight direction and confirmation switch 206. If as shown in FIG. 5 the index 501 is selected, when the rotary switch 206c is rotated in the direction shown by the arrow sign S, then the indexes are selected in the order index 507→index 502→index 508 . . . , in other words in a zigzag direction, as shown by the arrow sign 516. And, when the rotary switch 206c is actuated in the anticlockwise rotational direction, then the order in which the indexes are successively selected is the opposite order to the arrow sign 516.

That index 501 through 512 which has been selected with the rotary switch 206c is confirmed by the confirmation button 206b of the eight direction and confirmation switch 206 being pressed down, and then the map 513 is displayed at a scale at which the distance which is displayed upon that one of the indexes 501 through 512 is equivalent to horizontal width of the map 513. In other words, the indexes 501 through 512 may also be selected and confirmed with the two actuation members which are provided upon the actuation panel 201 which is the input device 17, i.e. with the rotary switch 206c and the confirmation button 206b. The input device 17 and the touch panel 18 constitute an instruction device which is actuated (operated) for instructing selection of one of the indexes 501 through 512.

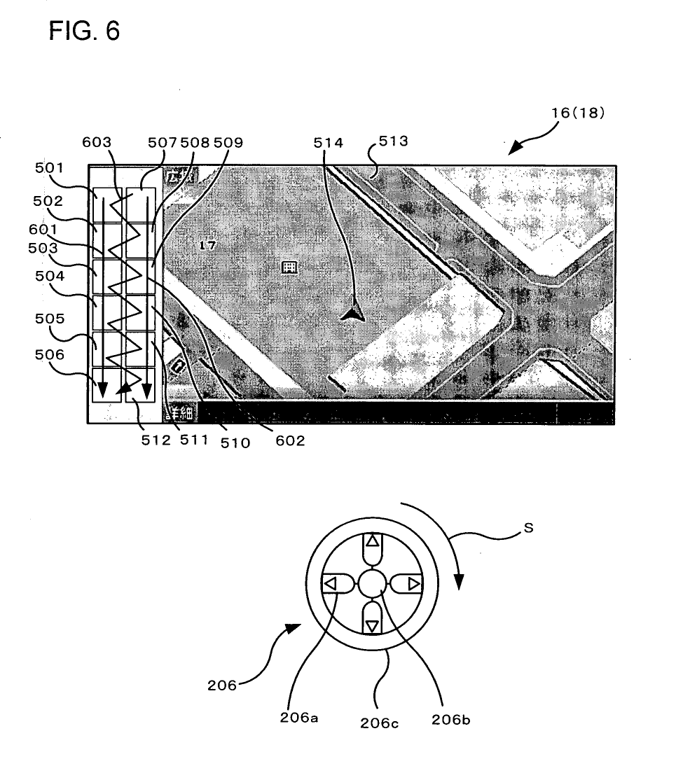

This navigation device according to the first embodiment of the present invention provides the following operation and beneficial effects.
(1) The indexes 501 through 512 are displayed by being lined up in two columns in the vertical direction. Accordingly the length in the vertical direction of each of the indexes 501 through 512 becomes twice as great, as compared to the case in which the indexes are displayed as a list arranged as a sequence of oblong rectangles along a single vertical line. Due to this, it becomes simple and easy to select one of the indexes 501 through 512 by pressing upon the touch panel 18. In order to make the size of the indexes 501 through 512 be such that it is possible easily to press upon the range of the display in which each one of the indexes 501 through 512 is displayed with a finger, it is desirable for this size to include a circle 515 of diameter 1 cm.
(2) Due to the displaced arrangement of the indexes 501 through 512 in the vertical direction and the orientations of the vertexes of the indexes in the left and right columns, it is possible to recognize visually that the index towards which the vertex of each index is pointing is the next index to be selected when the rotary switch 206c is rotated in the direction of the arrow sign S. Accordingly, when the rotary switch 206c is rotated in the direction of the arrow sign S, it can be understood at a single glance that the position of the selected one of the indexes 501 through 512 shifts in the sequence shown by the arrow sign 516. On the other hand if, as shown in FIG. 6, the indexes 501 through 512 were simply to be arranged in two vertical columns, then the position of the selected one of the indexes 501 through 512 would either shift in the vertical direction as shown by the arrow signs 601, 602, or would shift along therewith in a zigzag direction as shown by the arrow sign 603, so that it could not be understood at a single glance.

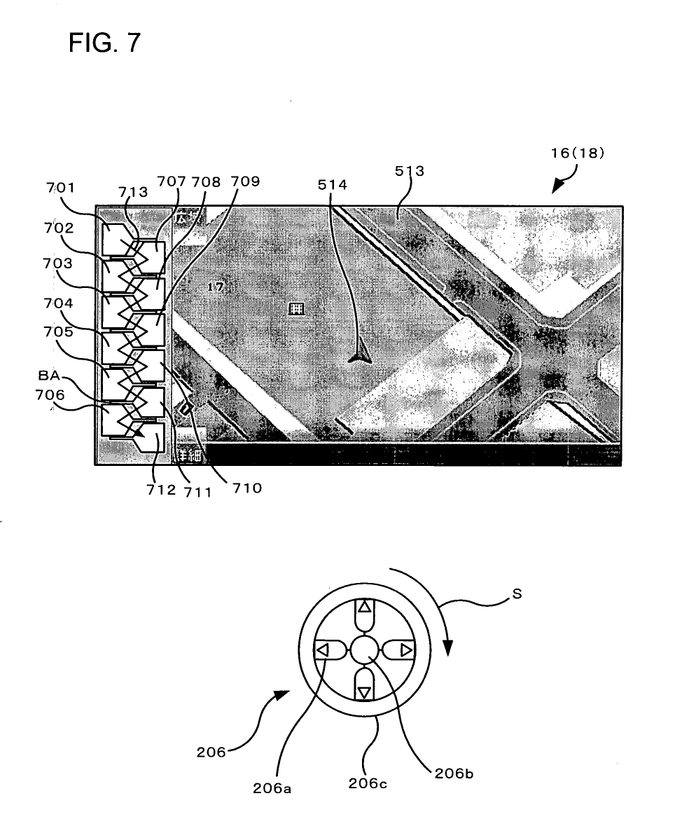

Next, a navigation device 1A according to a second embodiment of the present invention will be explained with reference to FIG. 7. FIG. 7 is a figure for explanation of a screen displayed upon the touch panel 18 of this navigation device 1A according to the second embodiment of the present invention, upon which indexes are displayed. The aspect in which these indexes 701 through 712 are different from the first indexes 501 through 512, is that thin bars BA are extended leftwards and rightwards from the vertexes of the indexes 701 through 712, and each of these bars BA is interposed between the indexes which are adjacent thereto in the upwards and downwards directions. To put this in another manner, bars BA which constitute portions of the indexes 702 through 706 in the left side column are interposed between those of the indexes 707 through 712 which are adjacent to each other in the right side column, while bars BA which constitute portions of the indexes 707 through 711 in the right side column are interposed between those of the indexes 701 through 706 which are adjacent to each other in the left side column.

By the bars BA being interposed between the indexes which are adjacent to each other in the upwards and downward directions in this manner, when the rotary switch 206c is rotationally actuated, if the direction of this actuation is the clockwise rotational direction, then it is possible simply and easily to recognize that the index which is positioned below the tip end portion of the bar BA which extends from the vertex of the index which is currently selected is the next index which will be selected. And, if the direction of this actuation is the anticlockwise rotational direction, then it is possible simply and easily to recognize that the index which is positioned above the tip end portion of the bar BA which extends from the vertex of the index which is currently selected is the next index which will be selected. Furthermore, it is also possible to obtain the same beneficial operational effect as with the navigation device 1 of the first embodiment, due to the indexes being arranged in two columns in the vertical direction.

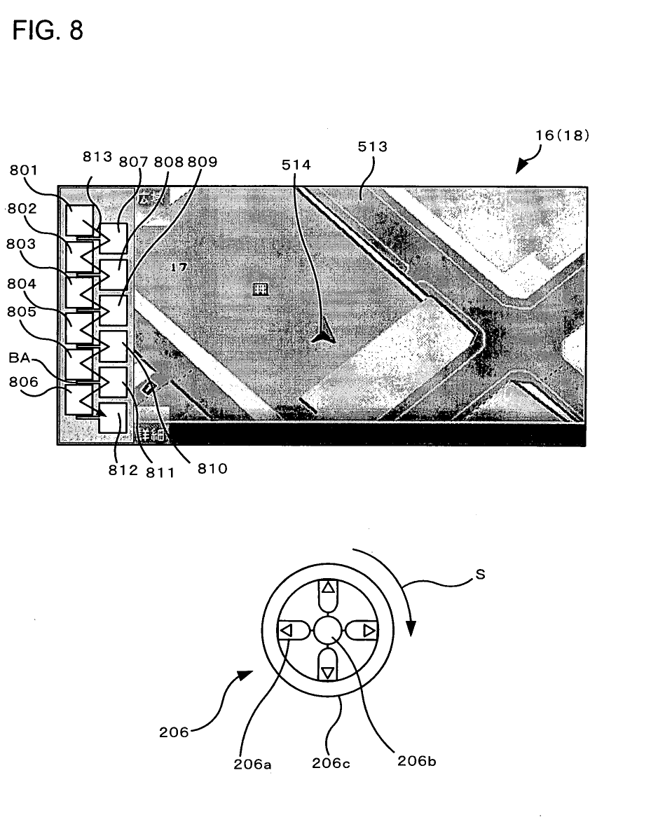

Next, a navigation device 1B according to a third embodiment of the present invention will be explained with reference to FIG. 8. FIG. 8 is a figure for explanation of a screen displayed upon the touch panel 18 of this navigation device 1B according to the third embodiment of the present invention, upon which indexes are displayed. The aspect in which these indexes 801 through 812 are different from the second indexes 701 through 712, is that the shape of the indexes 801 through 812 from which the thin bars BA project is not a convex shape, and that thin bars BA are only extended from the indexes 807 through 812 in one of the two columns of indexes 801 through 812 towards the indexes 801 through 806 in the other one of those columns, and are interposed between the indexes which are adjacent thereto in the upwards and downwards directions. To put this in another manner, the bars BA which constitute portions of the indexes 806 through 811 in the right side column are interposed between those of the indexes 801 through 806 which are adjacent to each other in the right side column.

By the bars BA being interposed only between the indexes of one of the columns which are adjacent to each other in the upwards and downward directions in this manner as well, when the rotary switch 206c is rotationally actuated, if the direction of this actuation is the clockwise rotational direction, then it is possible simply and easily to recognize that the index which has the bar BA which is positioned below the index which is currently selected, or the index which is positioned below the tip end portion of the bar BA of the index which is currently selected, is the next index which will be selected. And, if the direction of this actuation is the anticlockwise rotational direction, then it is possible simply and easily to recognize that the index which has the bar BA which is positioned above the index which is currently selected, or the index which is positioned above the tip end portion of the bar BA of the index which is currently selected, is the next index which will be selected. Furthermore, it is also possible to obtain the same beneficial operational effect as with the navigation device 1 of the first embodiment, due to the indexes being arranged in two columns in the vertical direction.

Although, in these embodiments of the present invention, the indexes 501 through 512, 701 through 712, and 801 through 812 were buttons which changed the scale of the map 513, the present invention is not limited to these embodiments. For example, it would also be acceptable for these buttons to be indexes for cueing destination lists when setting the destination for route searching by place name.

It should be understood that the functions which are allocated to the plurality of indexes 501 through 512 may be sequentially allocated in a zigzag to the indexes of the left and right columns from the top, in a predetermined sequence which these functions mean. In the example of FIG. 5, they are allocated in a zigzag from top to bottom in a sequence in which the scale ratio sequentially increases (becoming finer). By doing this, it becomes possible to ascertain this sequence at a single glance, even though the indexes are arranged in two columns. It should be understood that the sequence of functions which are allocated to the indexes in this manner corresponds to the sequence in which they are sequentially selected with the rotary switch 206c.

Although, in these embodiments of the present invention, it was arranged to be able to select the selection of the indexes being displayed upon the touch panel 18 with the rotary switch 206c, this arrangement is not particularly limited, provided that it is a switch or button which selects the indexes by two types of actuation (such as a device which is actuated in a straight line direction). In the case of the rotary switch 206c, although selection of the indexes was performed by rotation of the switch left and right, it would also be acceptable to arrange, for example, to be able to select the indexes by employing two buttons upon the actuation panel (in which case, when one of the buttons is pressed, the selection position varies in the same manner as when the rotary switch was rotated to the right, while, when the other of the buttons is pressed, the selection position varies in the same manner as when the rotary switch was rotated to the left, or the like). Furthermore, apart from using buttons or switches upon the actuation panel, it would also be acceptable to arrange for it to be possible to perform the selection from a joystick or the like upon a remote control.

Although various embodiments and variations thereof have been explained above, the present invention is not to be considered as being limited by the disclosed details. Other forms considered to fall within the scope of the technical concept of the present invention are also included within its range.

The contents of the disclosure of the following patent application upon which priority right is claimed are hereby incorporated by reference:

Japanese Patent Application 2004-269885 (filed on Sep. 16, 2004).

1. A navigation device, comprising:
a display device;
a control device that controls the display device so as to display a plurality of indexes to be selected in order to operate predetermined functions; and
an instruction device with which a user gives an instruction to select among the plurality of indexes that are displayed, wherein:
the control device displays the plurality of indexes so that the plurality of indexes are arranged in two columns in a vertical direction, indexes that are arranged in one of the two columns and indexes that are arranged in the other of the two columns are mutually displaced in a vertical direction, and the indexes that are arranged in at least the one of the two columns have shapes that project towards the other of the two columns of indexes.

2. A navigation device according to claim 1, wherein:
the control device displays the plurality of indexes so that the indexes that are arranged in the one of the two columns have shapes that project towards the other of the two columns of indexes, and the indexes that are arranged in the other of the two columns have shapes that project towards the one of the two columns of indexes.

3. A navigation device according to claim 2, wherein:
the control device displays the plurality of indexes so that portions of indexes that are arranged in the one of the two columns are arranged between two indexes adjacent to each other in the other of the two columns, and portions of indexes that are arranged in the other of the two columns are arranged between two indexes adjacent to each other in the one of the two columns.

4. A navigation device according to claim 1, wherein:
the control device displays the plurality of indexes so that portions of indexes that are arranged in the one of the two columns are arranged between two indexes adjacent to each other in the other of the two columns.

5. A navigation device according to claim 1, wherein:
the instruction device comprises a touch panel that is provided upon a display screen of the display device, and outputs a signal related to a position at which the touch panel is pressed to the control device; and
the control device decides that an index corresponding to the pressed position has been selected, based upon the signal related to the pressed position.

6. A navigation device according to claim 5, wherein:
the instruction device further comprises, in addition to the touch panel, an actuation member that is actuated for selecting among the indexes; and
the control device displays the indexes in the one of the two columns and the indexes in the other of the two columns to be sequentially and alternately selected, when the actuation member is continually actuated.

7. A navigation device according to claim 1, wherein:
the instruction device comprises an actuation member that is actuated for selecting among the indexes; and
the control device displays the indexes in the one of the two columns and the indexes in the other of the two columns to be sequentially and alternately selected, when the actuation member is continually actuated,.

8. A navigation device according to claim 6, wherein:
the actuation member is a rotary actuation member;
any one of the indexes is selected by rotational actuation of the rotary actuation member; and
there is further provide a confirmation actuation member that is actuated in order to confirm the selected index.

9. A navigation device according to claim 7, wherein:
the actuation member is a rotary actuation member:
any one of the indexes is selected by rotational actuation of the rotary actuation member; and
there is further provide a confirmation actuation member that is actuated in order to confirm the selected index.
